(19) United States
(12) Patent Application Publication
(10) Pub. No.: US 2017/0308705 A1
(43) Pub. Date: Oct. 26, 2017

(54) SYSTEM, DEVICE AND METHOD FOR ANTI-ROLLBACK PROTECTION OF OVER-THE-AIR UPDATED DEVICE IMAGES

(71) Applicant: QUALCOMM Incorporated, San Diego, CA (US)

(72) Inventors: Chad Karaginides, Ramona, CA (US); Xu Guo, San Jose, CA (US); Eugen Pirvu, Mission Viejo, CA (US); Dhaval Patel, San Diego, CA (US); Ron Keidar, San Diego, CA (US); Amit Shukla, Fremont, CA (US); Selvaraj Jaikumar, San Diego, CA (US); Yau Chu, Milpitas, CA (US)

(21) Appl. No.: 15/136,752

(22) Filed: Apr. 22, 2016

(51) Int. Cl. G06F 21/57; G06F 9/44; G06F 9/445; H04L 29/08; H04L 29/06

(52) U.S. Cl. CPC G06F 21/575; H04L 67/34; H04L 63/0876; G06F 8/665; G06F 9/4406; G06F 2221/033

(57) ABSTRACT

Technologies for updating a processing device, where a first device image is stored in a first (non-volatile) memory. When a new second device image is received via a communication interface, a first boot of the device is performed and a boot loader performs security processing on the second device image. Once security processing has passed, the second device image is set as a trial image and executed. The executed image is monitored to determine if predetermined operational parameters in the device are met. If the parameters are met, the second device image is set as a current image and the first device image is deactivated. A second boot is performed to make the new image operational for the device and the anti-rollback version one-time programmable fuses are blown. If the parameters are not met, the device revers to the first device image.

### BACKGROUND

### Field

Various features relate to techniques for providing anti-rollback protection for processing devices capable of performing over-the-air (OTA) updating of processing device images. Alternately and/or in addition, various features relate to techniques for efficiently rolling back updates that are faulty or cause failure in the processing device.

### Background

Over-the-air programming (OTA) refers to various methods of distributing new software updates, configuration settings, and even updating encryption keys to devices like cellphones, set-top boxes or secure voice communication equipment (e.g., encrypted 2-way radios). One important feature of OTA is that one central location can send an update to all the users, who are unable to refuse, defeat, or alter that update, and that the update may apply immediately to every device on the channel. In the context of mobile devices OTA may include over-the-air service provisioning (OTASP), over-the-air provisioning (OTAP) or over-the-air parameter administration (OTAPA), or provisioning handsets with the necessary settings with which to access services such as WAP or MMS. More recently, with the new concepts of Wireless Sensor Networks and the Internet of Things (IoT), also referred to as Internet of Everything (IoE), where the networks consist of hundreds or thousands of nodes, OTA has been applied using unlicensed frequency bands (e.g., 2.4 GHz, 868 MHz, 900 MHz) and with low consumption and low data rate transmission using protocols such as 802.15.4 and ZigBee.

For IoE devices, Original Equipment Manufacturers (OEMs) typically require devices to have off-chip non-volatile memory (NVM) having partitions that include a trial (or “temporary”) image, a current image and a default (golden) image with respective firmware descriptors (FWD). When loading images, a primary boot loader (PBL) and/or secondary boot loader (SBL) in a processing device may load images, such as an operating system or other suitable software, based on the FWDs, where trial images may be loaded first, followed by current images and default (golden) images. The sequence of loaded images may be determined by a rank field in the FWD. A newly received OTA updated image is typically labeled as a trial image before it is authenticated. After authentication, the image may be set to a current image and, at the same time, the previous current image is invalidated.

Regarding device security, there is a known attack, referred to as a “rollback” attack, where a hacker may cause a device to run an older, and often insecure software version, instead of a current latest version of the code. One approach to combating such attacks is to enable a software-based anti-rollback protection by using on-chip one-time programmable (OTP) elements/fuses to record the last installed version, Under this approach, the PBL/SBL are configured to program the anti-rollback OTPs as part of an image authentication process, where the latest software version number is extracted from the image certificate. If the loaded version number is less than a current number (indicating an earlier version loading attempt), then the image is prevented from executing.

However, such approaches are problematic, For example, when a new version of an OTA image is received, it is executed as a trial image. If the OTA image crashes in the first execution after passing image authentication and blowing anti-rollback version OTPs, the previous current image is invalidated, which forces the device to restore itself using the factory-set default (golden) image. Additionally, while OTA images may be generally functional for core device functions, there may be instances of device specific applications that may be incompatible with the updated OTA image. This results in a needlessly rigid and complex process for OEMs to manage and control OTA updates with specific devices.

### SUMMARY

Various features relate to OTA image updating (e.g., software/programming updates) for a device while utilizing anti-rollback functionality in processing devices.

A first aspect provides a device comprising: a first memory for storing a first device image, a second memory for storing at least one boot loader, a communication interface for receiving a second device image, and a processing circuit coupled to the first memory, the second memory, and the communication interface. The processing circuit may be configured to (a) initiate a first boot for the device, (b) instruct the at least one boot loader to perform security processing on the second device image and set and execute the second device image as a trial image after security processing on the second device image is successful, (c) monitor the executed second device image to determine if predetermined operational parameters in the device are met, and/or (d) set the second device image as a current image and deactivate the first device image if the predetermined operational parameters in the device are met. The at least one boot loader may be configured to activate a second boot for the device after setting the second device image as a current image. The at least one boot loader may also be configured to modify a one-time programmable memory to indicate the setting of the second device image as the current image after setting the second device image as the current image. In one example, the one-time programmable memory may include a one-time programmable fuse. The at least one boot loader may also be configured to perform security processing via at least one of integrity check and/or authentication for the second device image. Additionally, the at least one boot loader may also be configured to deactivate the second device image and boot the device to load the first device image if the monitored executed second device image is determined to not meet the predetermined operational parameters. In one example, receiving the second device image may include an over-the-air (OTA) second device image.

A second aspect provides a method for updating a device, comprising: (a) storing a first device image and at least one boot loader in a first memory, (b) receiving a second device image via a communication interface, (c) initiating a first boot of the device, (d) instructing the at least one boot loader to perform security processing on the second device image and setting and executing the second device image as a trial image after security processing on the second device image is successful, (e) monitoring the executed second device image to determine if predetermined operational parameters in the device are met, and/or (f) setting the second device image as a current image and deactivate the first device image if the predetermined operational parameters in the device are met.

Additionally, the method may further include: (g) activating a second boot for the device after setting the second device image as a current image, and/or (h) modifying a one-time programmable memory to indicate the setting of the second device image as the current image after setting the second device image as the current image. In one example, modifying the one-time programmable memory includes blowing a one-time programmable fuse.

Performing security processing may include performing at least one of integrity check and/or authentication for the second device image via at least one of a primary boot loader and/or a secondary boot loader. Additionally, the method may further include deactivating the second device image and booting the device to load the first device image if monitoring the executed second device image determined the predetermined operational parameters are not met. In one example, receiving the second device image may include receiving an over-the-air (OTA) second device image,

A third aspect may also provide a machine-readable storage medium having instructions stored thereon which when executed by a processing circuit causes the processing circuit to: (a) store a first device image in a first memory, (b) receive a second device image via a communication interface, (c) initiate a first boot of the processing circuit, (d) instruct at least one boot loader to perform security processing on the second device image and set and execute the second device image as a trial image after security processing on the second device image is successful, (e) monitor the executed second device image to determine if predetermined operational parameters in a device are met, (f) set the second device image as a current image and deactivate the first device image if the predetermined operational parameters in the device are met, (g) activate a second boot for the device after setting the second device image as a current image, (h) modify a one-time programmable memory to indicate the setting of the second device image as the current image after setting the second device image as the current image, and/or (i) deactivate the second device image and booting the processing circuit to load the first device image if monitoring the executed second device image determined the predetermined operational parameters are not met. The instructions to perform security processing includes instructions to perform at least one of integrity check and/or authentication for the second device image via at least one of a primary boot loader and/or a secondary boot loader.

### DRAWINGS

Various features, nature and advantages may become apparent from the detailed description set forth below when taken in conjunction with the drawings in which like reference characters identify correspondingly throughout.

FIG. 1 illustrates an exemplary system that includes a processing device and a server device communicating via a network, wherein the processing device may be configured with anti-rollback capabilities and configured to receive over-the-air image updates.

FIG. 2 illustrates an exemplary operating environment for an off-chip non-volatile memory device of FIG. 1 that includes a default image, a trial image, and a current image.

FIG. 3 illustrates an exemplary operating environment for the server device of FIG. 1 for managing and transmitting over-the-air images to a device.

FIG. 4 illustrates an exemplary operating environment for the server device of FIG. 1 for securing images for transmission to one or more devices under an illustrative embodiment.

FIG. 5 shows an operating environment for the processing device of FIG. 1 for authenticating OTA images under an illustrative embodiment.

FIG. 6 shows a partition table configured to identify and manage processing device images in a processing device under an illustrative embodiment.

FIG. 7 shows a field and value designation for a partition table to monitor and update signatures, versions and types for the partition table under an illustrative embodiment.

FIG. 8 shows a firmware descriptor structure suitable for use in securely processing OTA updates utilizing OTA signatures, rank, status and firmware images under an illustrative embodiment.

FIG. 9 (comprising FIGS. 9A, 9B, and 9C) illustrates an exemplary method for securely performing an aver-the-air update of software and/or programming for a device.

FIG. 10 illustrates an exemplary block diagram of a device configured to perform over-the-air updates with anti-rollback security.

FIG. 11 (comprising FIGS. 11A and 11B) illustrates a method for updating a device image (e.g., programming and/or software) with anti-rollback capabilities.

### DETAILED DESCRIPTION

The figures and descriptions provided herein may have been simplified to illustrate aspects that are relevant for a clear understanding of the herein described devices, structures, systems, and methods, while eliminating, for the purpose of clarity, other aspects that may be found in typical similar devices, systems, and methods. Those of ordinary skill may thus recognize that other elements and/or operations may be desirable and/or necessary to implement the devices, systems, and methods described herein. But because such elements and operations are known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Exemplary embodiments are provided throughout so that this disclosure is sufficiently thorough and fully conveys the scope of the disclosed embodiments to those who are skilled in the art. Numerous specific details are set forth, such as examples of specific components, devices, and methods, to provide this thorough understanding of embodiments of the present disclosure. Nevertheless, it will be apparent to those skilled in the art that specific disclosed details need not be employed, and that exemplary embodiments may be embodied in different forms. As such, the exemplary embodiments should not be construed to limit the scope of the disclosure. In some exemplary embodiments, well-known processes, well-known device structures, and well-known technologies may not be described in detail.

The terminology used herein is for the purpose of describing particular exemplary embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The steps, processes, and operations described herein are not to be construed as necessarily requiring their respective performance in the particular order discussed or illustrated, unless specifically identified as a preferred order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another element, component, region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

The disclosed embodiments may be implemented, in some cases, in hardware, firmware, software, or any tangibly-embodied combination thereof. The disclosed embodiments may also be implemented as instructions carried by or stored on one or more non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

### Overview

Some features pertain to updating over-the-air (OTA) transmitted programming and/or software packages referred to herein as “images”) while using anti-rollback features for a processing device. The processing device may reboot (“boot”) after receiving an upgraded OTA image and authenticating the OTA image using specified security protocols (e.g., verifying a digital signature aver the OTA image). Once authenticated, the updated OTA image may be set as a trial (or temporary) image and executed on the device. During this period, the processing device operational parameters and/or operational data is monitored to determine if any operational issues exist with the trial image on the device. Once the processing device passes the monitoring of the trial image, the updated OTA image is set as a current image in the processing device, and the previous image is deactivated. Upon a second reboot, the updated OTA image is made operational on the processing device and corresponding anti-rollback version OTP fuses are blown.

### Exemplary System for Processing OTA Updates Utilizing Anti-Rollback Functionality

Many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence of actions described herein can be considered to be embodied entirely within any tangible form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

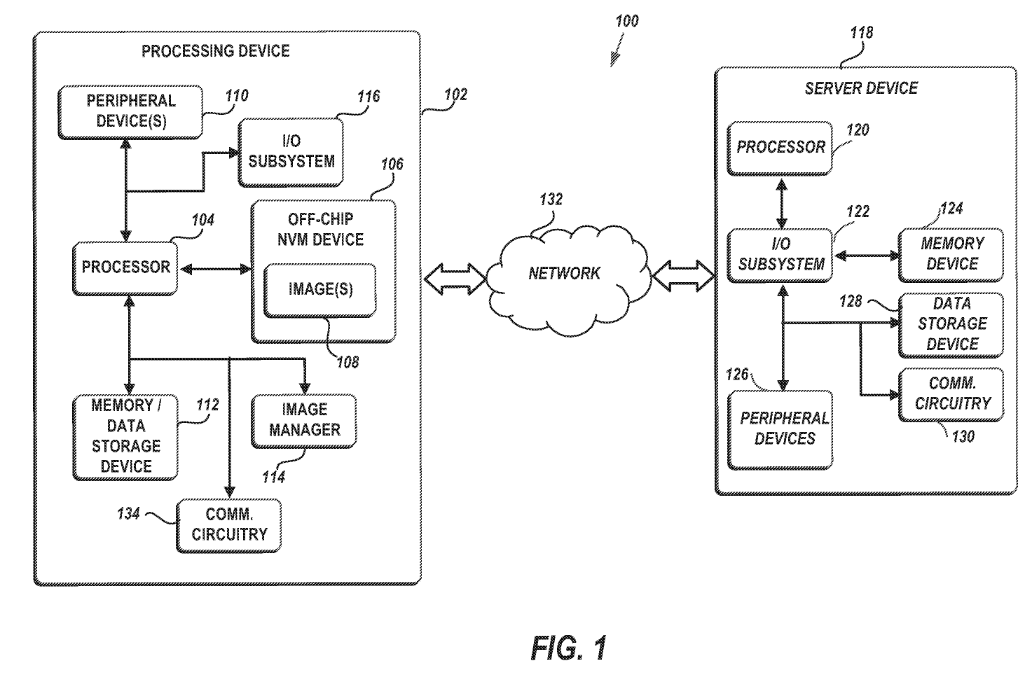

FIG. 1 illustrates an exemplary system 100 comprising a processing device 102 communicatively coupled to one or more server devices 118 via a network 132, the processing device may be configured with anti-rollback capabilities and configured to receive over-the-air image updates. The processing device 102 may be embodied as any type of computing device capable of performing the functions described herein. For example, a processing device may be embodied as, but is not limited to, a computer, a desktop computer, a personal computer (PC), a tablet computer, a laptop computer, a notebook computer, a mobile computing device, a smart phone, a cellular telephone, a system-on-chip (SoC), a handset, a messaging device, a work station, a network appliance, a web appliance, a distributed computing system, a multiprocessor system, a processor-based system, a consumer electronic device, a digital television device, a set top box, and/or any other computing device configured to store and access data, and/or to execute electronic cloud software and related applications. Note that the term “image” broadly refers to programming, instructions, software (e.g., applications, operating system, and/or firmware, etc.).

In FIG. 1, the processing device 102 may include a processor 104 (or processor circuit), an off-chip non-volatile memory (NVM) device 106, that may be configured to store one or more device images 108, one or more peripheral devices 110, memory/data storage device 112 and an image manager 114. The image manager 114 may be configured to process and/or monitor images 108 stored in the off-chip NVM device 106 (e.g., ROM, EPROM, flash memory), The image manager 114 may be incorporated into the off-chip NVM device 106, or may be a dedicated component, or incorporated into (or executed by) the processor 104. Of course, the processing device 102 may include other or additional components, such as those commonly found in a digital devices and/or computer (e.g., communication circuitry, various input/output devices). Additionally, in some embodiments, one or more of the illustrative components may be incorporated in, or otherwise form a portion of, another component. For example, the memory/data storage device 112, or portions thereof, may be incorporated in the processor 104 in some embodiments.

The processor 104 may be embodied as any type of processor currently known or developed in the future and capable of performing the functions described herein, For example, the processor 104 may be embodied as a single or multi-core processor(s), digital signal processor, microcontroller, or other processor or processing/controlling circuit. Similarly, the memory/data storage device 112 may be embodied as any type of volatile or non-volatile memory or data storage device currently known or developed in the future and capable of performing the functions described herein. In operation, the memory/data storage device 112 may store various data and software used during operation of the processing device 102 such as one or more boot loaders, operating systems, applications, programs, libraries, and drivers.

The memory/data storage device 112 may be communicatively coupled to the processor 104 via an I/O subsystem 116, which may be embodied as circuitry and/or components to facilitate input/output operations with the processor 104, memory/data storage device 112, and other components of the processing device 102. For example, the I/O subsystem 116 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 116 may form a portion of a system-on-a-chip (SoC) and be incorporated, along with the processor 104, the memory/data storage device 112, and other components of the processing device 102, on a single integrated circuit chip.

The processing device 102 includes communication circuitry 134 (also referred to as a communication interface) that may include any number of devices and circuitry for enabling communications between processing device 102 and one or more other external electronic devices and/or systems. Similarly, peripheral devices 110 may include any number of additional input/output devices, interface devices, and/or other peripheral devices. The peripheral devices 110 may also include a display, along with associated graphics circuitry and, in some embodiments, may further include a keyboard, a mouse, audio processing circuitry (including, e.g., amplification circuitry and one or more speakers), and/or other input/output devices, interface devices, and/or peripheral devices.

The server device 118 may be embodied as any type of server device (e.g., a web server, etc.) or similar computing device capable of performing the functions described herein. In the illustrative embodiment of FIG. 1 the server device 118 includes a processor 120, an I/O subsystem 122, a memory device 124, a data storage device 128, communication circuitry 130, and one or more peripheral devices 126. Components of the server device 118 may be similar to the corresponding components of the processing device 102, the description of which is applicable to the corresponding components of server device 118 and is not repeated herein for the purposes of brevity.

The communication circuitry 130 of the server device 118 may include any number of devices and circuitry for enabling communications between the server device 118 and the processing device 102. In some embodiments, the server device 118 may also include one or more peripheral devices 126. Such peripheral devices 126 may include any number of additional input/output devices, interface devices, and/or other peripheral devices commonly associated with a server or computing device.

In the illustrated embodiment, communication between the server device 118 and the processing device 102 takes place via a network 132 that may be operatively coupled to one or more network switches (not shown). In one embodiment, the network 132 may represent a wired and/or wireless network and may be or include, for example, a local area network (LAN), personal area network (PAN), storage area network (SAN), backbone network, global area network (GAN), wide area network (WAN), or collection of any such computer networks such as an intranet, extranet or the Internet (i.e., a global system of interconnected network upon which various applications or service run including, for example, the World Wide Web). Generally, the communication circuitry of processing device 102 and the communication circuitry 130 of the server device 118 may be configured to use any one or more, or combination, of communication protocols to communicate with each other such as, for example, a wired network communication protocol (e.g., TCP/IP), a wireless network communication protocol (e.g., WiMAX), a cellular communication protocol (e.g., Wideband Code Division Multiple Access (W-CDMA)), and/or other communication protocols. As such, the network 132 may include any number of additional devices, such as additional computers, routers, and switches, to facilitate communications between the processing device 102 and the server device 118.

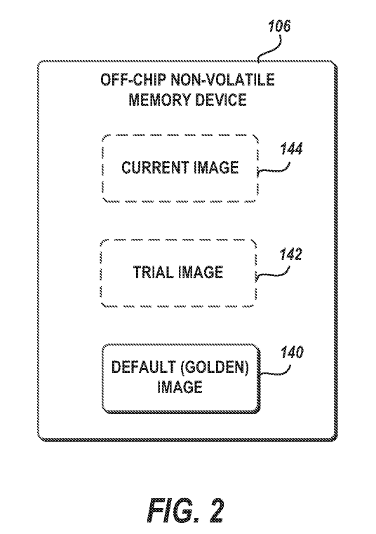

FIG. 2 illustrates an exemplary operating environment for the off-chip NVM device 106 of the processing device 102. In this example the off-chip NVM device 106 may include/store a default (e.g., golden) image 140, a trial image 142 and a current image 144. In one example, a default image (e.g., default image 140) may be configured as a compressed archive of an entire installed and configured system (default, base, or golden system) for the processing device 102. In certain illustrative embodiments, administrators may create default images (e.g., default image 140) to ease the installation process for multiple installs on processing devices. Default systems may include patches, kernel parameter settings, common software, and/or spooler configurations, among others, and multiple default images may be created that are specific to a processor device environment. For the purposes of certain embodiments, the term “golden image” may refer as a default or base image that, for example, may be pre-installed on a device. The off-chip NVM 106 may be configured to partition the default image 140, trial image 142 and current image 144 so that, when new updated images are received, they may be run initially in a trial image environment (142) for a predetermined period of time while the processing device's operating parameters are monitored. Once the operating parameters are determined to be operating correctly, the new updated image is set as a current image for use thereafter by the processing device 102.

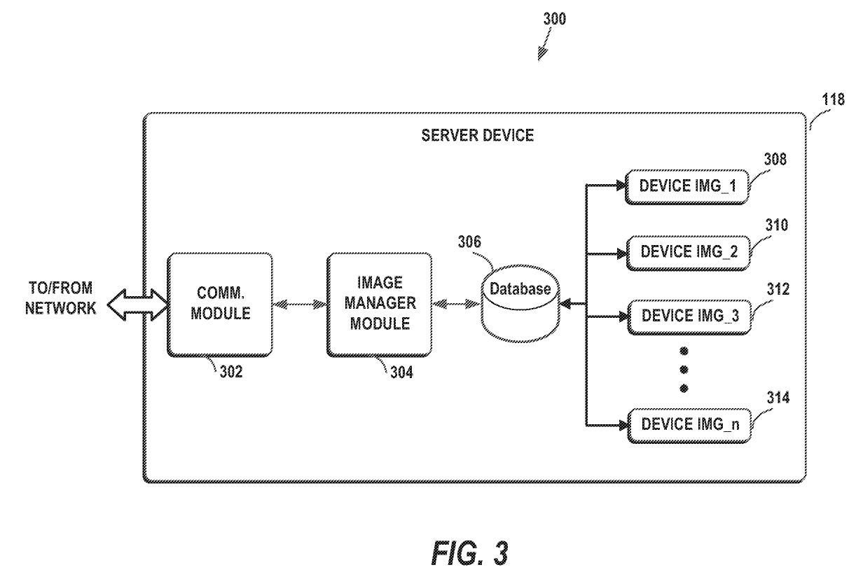

FIG. 3 illustrates an exemplary operating environment 300 of the server device 118 is shown. In one example, the server device 118 may include an image manager module 304 that is communicatively coupled to a database 206 that has stored on it one or more processor device images (308, 310, 312, 314). The image manager module 304 may monitor the images 308, 310, 312, and 314 to determine image characteristics, such as image version, current version, old version, and the like. In one example, the image manager module 304 may perform security processing on the device images 308, 310, 312, and 314 for securing OTA images in a trusted environment for transmission via a communication module 302. The security processing may include, but is not limited to, integrity check to ensure that data of, or relating to, any of the processing device images, was not altered. The security processing may also include, but is not limited to, authentication to ensure the processing device images were received from a credentialed source. In another example, security processing may be performed in a different module or component of the server device 118. In a further example, security processing may be performed on another server device for one or more device images 308, 310, 312, and/or 314.

### Exemplary Operating Environments for Securing and Authenticating OTA-Transmitted Software/Programming

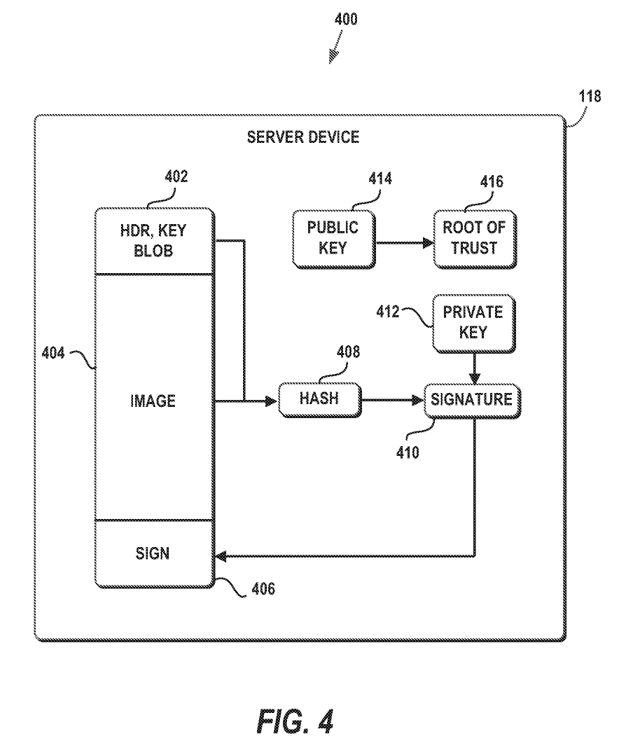

FIG. 4 illustrates an exemplary operating environment 400 for the server device 118 for securing and/or providing OTA images. It should be understood by those skilled in the art that the operating environment 400 may be incorporated on other servers of devices, and that the present disclosure is not limited only to the server device 118. As the image manager module 304 (or other suitable module) loads or creates an image 404, a hash 408 (e.g., over the image 404) may be created using security parameters 402 that may include a security header (HDR) for indicating payload encryption, and an associated key blob. A key blob may be configured to store encrypted keys to protect them when they are outside of a security boundary. A signature 410 may be created from the hash 408 and a private key 412, where the signature is associated 406 with the specific image 404. In an illustrative embodiment, a public key 414 may be used to create a root of trust 416.

The operating environment 400 may be used to define a security boundary (or “secure environment” or “trusted environment”) of the images transmitted to the processing device 102. The definition of the security boundary may affect the desired protection on interfaces and the way in which sensitive security parameters (SSPs), firmware and software are protected. The root of trust 416 may be configured to store private (secret) data for the system, provide trusted functions and extend trust to other devices or entities via the functions and secrets. In one illustrative embodiment, the root of trust may be configured as a hardware root of trust, which is typically more secure than a software-based root of trust. Data stored in the root of trust 416 includes, but is not limited to, chip master key or root key, public secure boot key, authentication key(s), secure data storage key(s) and other system-specific parameters used to describe the behavior of the system. When inside the security boundary of an operating environment, decryption keys may be determined using a master key as a key blob decryption key. A master key may be configured as a secret key that is not available to any resource except a secure boot environment. Once a decryption key is recovered, it may be used in a secure boot process to decipher the source code.

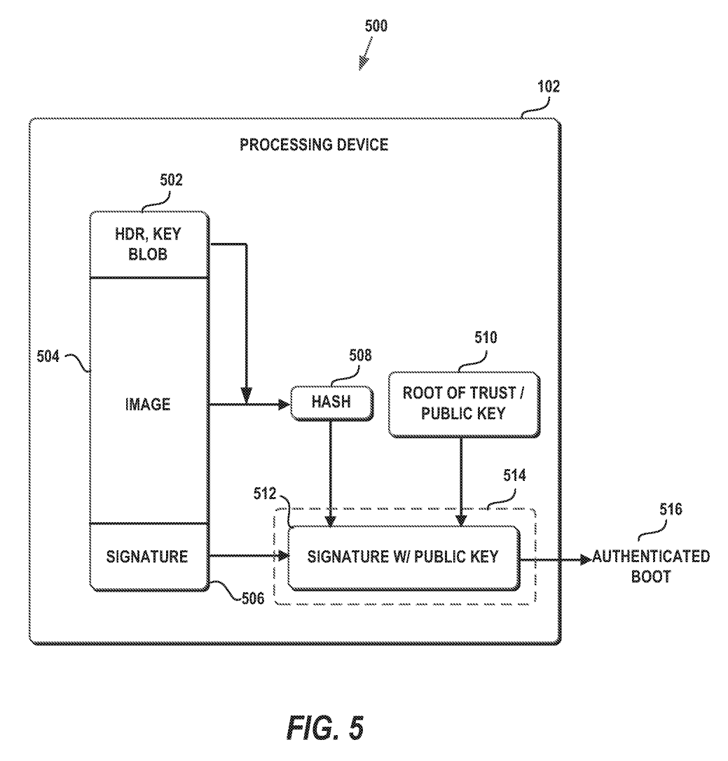

FIG. 5 illustrates an exemplary operating environment 500 for the processing device 102, where the processing device 102 may be configured to authenticate an image (e.g., updated OTA image) received from the server device 118 and perform a secure boot. A secure boot may be considered a process for providing software and configuration integrity checking and authentication. In certain illustrative embodiments, before an image is allowed to run on the processor, the image is integrity checked, to ensure that it has not been altered, and authenticated to determine that the image was created by the correct party. The received image 504, along with security parameters 502 and a signature 506 are received in processing device 102, wherein the hash 408 is obtained and used with the root of trust and a public key 510 and a signature 506 to perform integrity checking and authentication in 512, which may be performed by one or more boot loaders 514. If the integrity checking an authentication pass, the processing device 102 may initiate an authenticated boot 516.

In certain illustrative embodiments, a system manufacturer may want to retain the ability to revoke former versions of software (image) that may be deemed insecure. An old image that is correctly signed may run on the processing device 102 unless an anti-rollback check is provided. Accordingly, a current version of the image may be part of a secure boot header. The anti-rollback check may compare the version to a minimally acceptable version of the image during a secure boot process. The current version may be protected as part of the integrity check. The boot process may be configured to be executed in several boot stages, and may include multiple loot loaders (e.g., PBL, SBL). A secure boot may depend on an initial boot loader program that checks the integrity of and authenticate the next boot stage using root of trust keys. Once the next boot stage is verified, the processor (e.g., 104) may execute a jump and start execution of the verified code. This process may be repeated for multiple stages, creating a “chain of trust” wherein software and configuration files are layered upon a previous stage. Each stage may be progressively checked so that, if any stage fails the secure boot check, the system will not boot and run. It should be understood by those skilled in the art that multiple different integrity checks and/or authentication techniques are contemplated in the present disclosure and that these techniques may be utilized alternately, or in addition to, the non-limiting embodiments disclosed herein.

### Exemplary Data Structure for Processing OTA Updates Utilizing Anti-Rollback Functionality

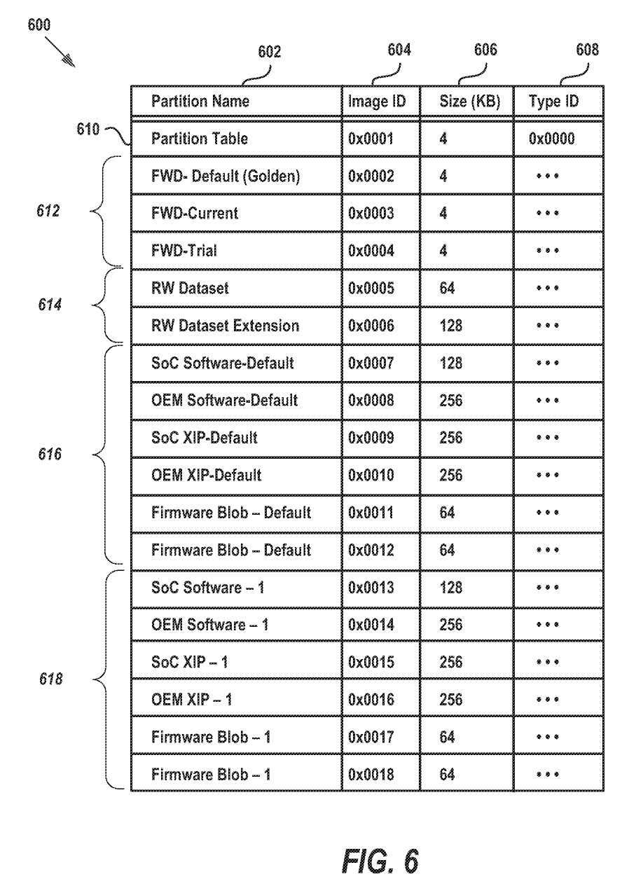

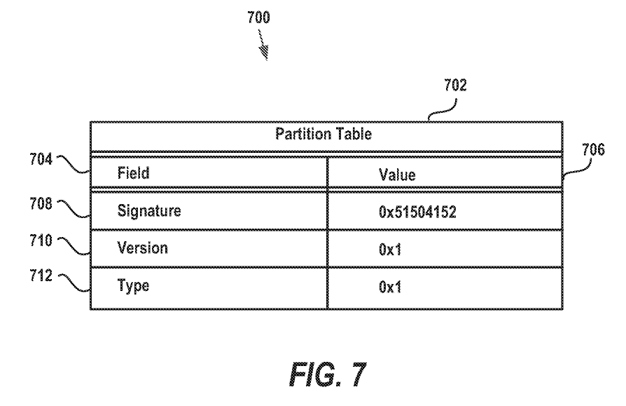

FIG. 6 illustrates an exemplary partition table 600 configured to identify and manage processing device images, such as those in the off-chip NVM device 106 in the processing device 102. In this example, when a processing device is powered up and booted, the firmware may load files specified in the partition table 600 to start installed operating systems and various utilities. The partition table 600 should be formatted with a file system specific to the processing device 102. The partition table may specify a partition name 602, image identification (ID) 604, size 606 and type 608. A partition table ID 610 may be specified as shown in FIG. 6 and discussed in greater detail below in connection with FIG. 7. The partition table 600 may also include firmware descriptors (FWD) 612 specifying default (golden), current and trial designations, along with read/write (RW) datasets and extensions 614. The partition table 600 nay also include the boot loader programs for all installed operating systems (which may be contained in other partitions on the same or any other local storage device), device driver files for hardware devices present in a processing device and used by the firmware at boot time, system utility programs that are intended to be run before an operating system is booted, and data files such as error logs. In the example of FIG. 6, such data may be stored in the partition table 600 for the default (golden) image 616 and a current image 618.

FIG. 7 illustrates an exemplary field and value designation for a partition table ID structure 700 for monitoring and updating signatures, versions and types for the partition table 610 (FIG. 6). The partition table 610 may be configured with a field heading 704 and a value 706 as shown in FIG. 7. The fields may include, but are not limited to, a signature field 708 for specifying a signature for validating an image, together with a version field 710 and a type field 712.

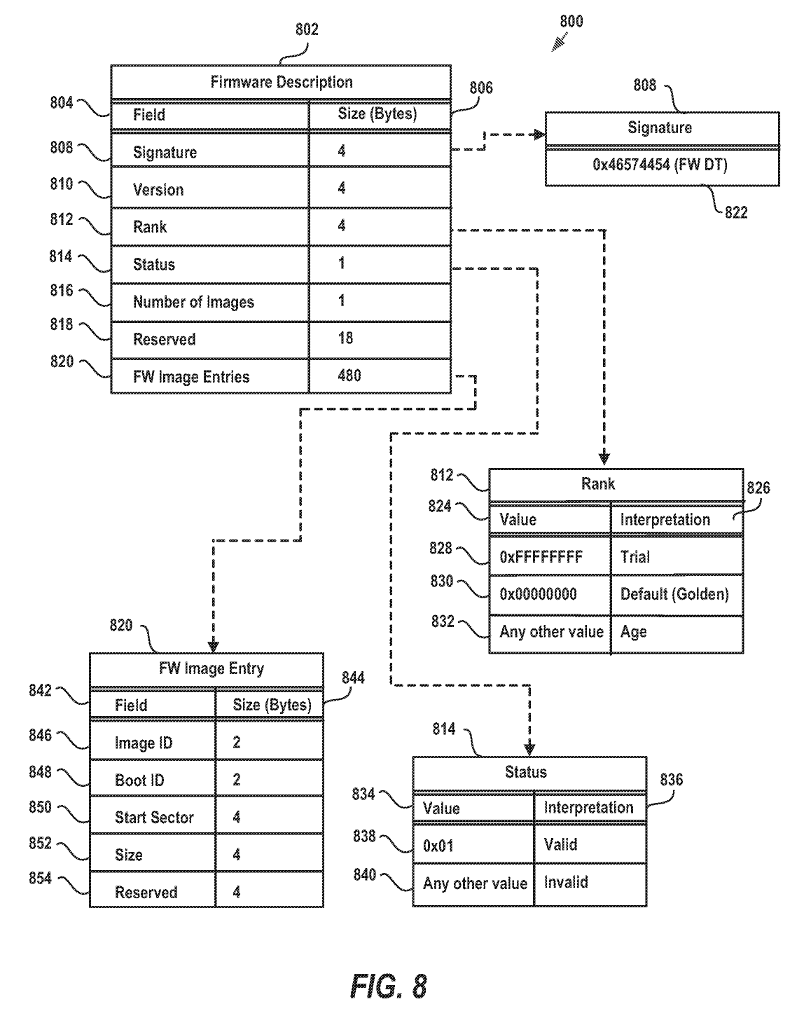

FIG. 8 illustrates an exemplary firmware descriptor structure 800 suitable for use in securely processing OTA updates utilizing OTA signatures, rank, status and firmware images. The FWD structure 800 may include a FWD table 802 specifying a field 804 and size 806, among other things. The specified fields 804 of FWD table 802 include, but are not limited to, a signature field 808, a version field 810, a rank field 812, a status field 814, a number of images field 816, a reserved field 818 and a firmware image entry field 820. The signature value 822 for signature 808 may be utilized to integrity check and authenticate updated images. The rank field 812 may include a value field 824 and interpretation field 826, where predetermined value fields may specify a rank (type) of image. In this example, a first predetermined value 828 may indicate an image is a trial image, while a second predetermined value 830 may indicate an image is a default (golden) image. One or more other values 832 may specify the age of the image (e.g., current image, non-current, older, image).

The status field 814 may include a value field 834 and an interpretation field 836, where a first status value 838 may indicate a valid image, while a second status value 840, which in this example may be any other value, may indicate an invalid image. The status field may be used by the FWD to invalidate older images, particularly after an OTA image upgrade is completed. The firmware image entry field 820 (e.g., descriptor) may include a value field 842 and size filed 844, among others. The firmware image entry descriptor value fields 842 may include, but are not limited to, an image identification field 846, a boot identification 848, a start sector 850, a size 852 and a reserved field 854 as shown in FIG. 8.

Exemplary Methods for Processing OTA Image Updates with Anti-Rollback Functionality

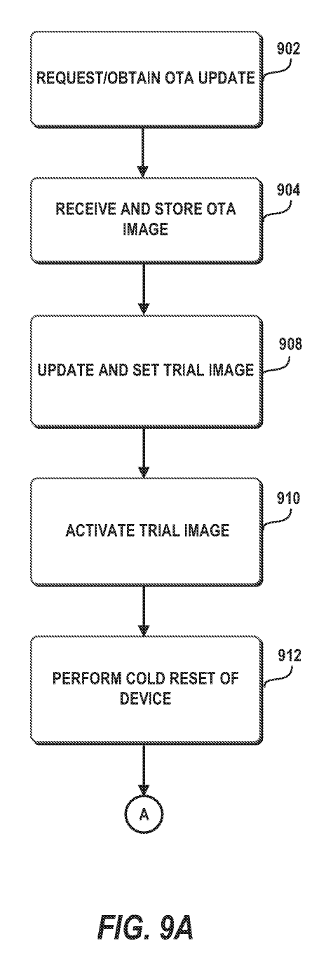

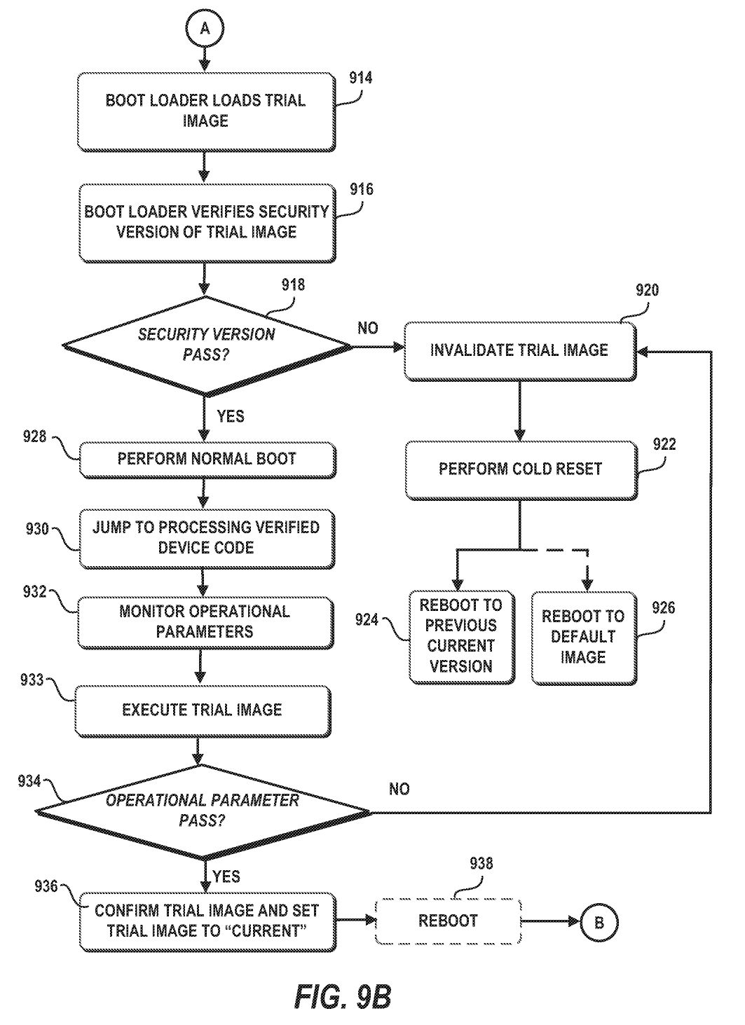

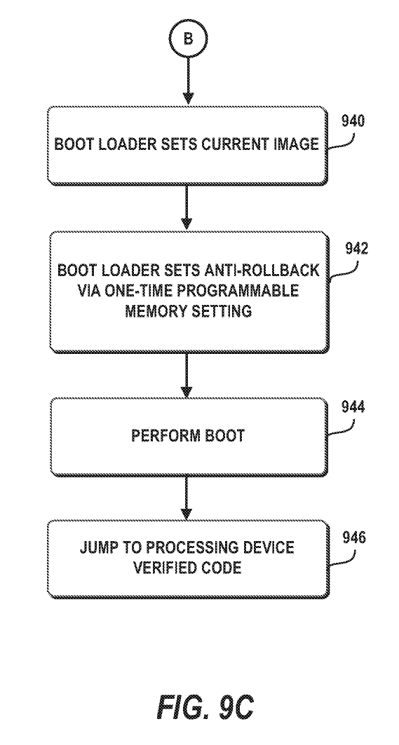

FIG. 9 (comprising FIGS. 9A, 9B, and 9C) illustrates an exemplary method for securely performing an over-the-air update of software and/or programming for a device.

FIG. 9A illustrates an exemplary stage of a method for securely performing an OTA update, where an OTA image is received, set, and activated as a trial image, followed by a cold reset of the processing device (e.g., processing device 102), An OTA image upgrade may be requested/obtained from a server device 902 (e.g., server device 118). This request may be generated within the server device, or made by an entity in communication with a network. In some illustrative embodiments, the request may be generated from a client device or processing device seeking to update its software and/or programming (e.g., operating system, boot firmware, applications, etc.), After receiving the request, the server device may load a requested device image. In one example, the request 902 may include executable instructions causing the receiving server device to determine (e.g., via the image manager module 304) a most current image in a server database (e.g., 306). If a more current image is available, the server device may transmit the current image via the communication module 302 to the requesting processing devices or processing device to be updated.

The processing device may receive and stores the OTA image 904. Once stored, the processing device may update and set the OTA image as a trial image 908 and activates the trial image 910. Once the trial image is activated, the processing device may perform a cold reset in 912 prior to performing further processing of the updated OTA image described below in connection with FIG. 8B, and continued in the figures via reference “A”.

FIG. 9B illustrates another exemplary stage of the method for securely performing an OTA update, where the trial image from FIG. 9A is loaded, subjected to security verification, and set as a current image when verified. A boot loader (e.g., a primary boot loader PBL) loads the trial image, and a boot loader (which may be the PBL, or a secondary boot loader SBL) verifies a security version of the trial image 916. The verification of the trial image 916 may include integrity checking and/or authentication of the image being loaded. The boot loader determines if the security version passed the integrity check/authentication 918.

If the security version does not pass (“NO”) the integrity check/authentication, the trial image is invalidated 920 and causes the processing device to perform a cold reset 922 of the processing device. After resetting, the processing device may reboot to the previous current version (i.e., the version prior to the update) 824 or reboot to the default (golden) image. In some embodiments, the integrity check and authentication 918 may be repeated for a predetermined number of attempts. If the predetermined number of attempts has been exceeded, the boot loader may automatically reboot from the default (golden) image.

If the security version integrity check/authentication 918 of the trial image passes (“YES”), the processing device performs a normal boot 928, and the processor executes a jump and starts execution of verified device code 930. In one illustrative embodiment, the device code may include capturing and/or monitoring algorithms that monitor operational parameters 932 on the processing device as the trial image is executed 933, Examples of operating system parameters include, but are not limited to, operating system parameters, software parameters, hardware parameters, driver parameters, application(s) compatibility and/or operation, etc. The monitoring algorithm(s) determine if the processing device operational parameters pass for the trial image (e.g., no software/application crashes, driver incompatibilities, etc.) 934. in one example, the monitoring may be configured such that it monitors operational parameters for a predetermined period of time (e.g., hours /days/weeks). If the operational parameters do not pass (“NO”), the process proceeds the trial image is invalidated 920 and a cold reset is performed 922. In this example, if there is a failure of processing device operational parameters, the process reboots to the previous current version of the image 924, and does not reboot to the default (golden) image. Such a configuration advantageously allows a device to “test” an updated OTA image in a trial mode before setting it as a current image, which may be an irreversible process. If the operational parameters pass (“YES”), the trial image is confirmed for use on the processing device 936 and set as a current image. In an optional step, the processing device may perform a reboot 938 after setting the trial image as a current image and prior to performing further processing of the updated OTA image described below in connection with FIG. 9C, and continued in the figures via reference “B”.

FIG. 9C illustrates another exemplary stage of the process for securely performing an OTA update, where the current image from FIG. 9B is loaded and the processing device updates and-rollback via a one-time programmable memory setting. The boot loader may set the current image 940 and sets an anti-rollback function by setting a one-time programmable memory 942 that permanently increments the current version value. In this manner, the processing device is able to check if a received “updated” image is really an earlier version (e.g., which may have security flaws), thus allowing the processing device to prevent loading and/or execution of image versions that are earlier than indicated by the one-time programmable memory. The one-time programmable memory may be configured as a programmable read-only memory (PROM) or field programmable read-only memory (FPROM) or one-time programmable non-volatile memory (OTP NVM), or any other form of digital memory where the setting of each bit is locked by blowing a fuse or antifuse. Once the current image programming is set, the processing device performs a second boot 944. After performing the second boot, the processing device restarts and the processor executes a jump and start execution of the verified (OEM) code using the updated current image 946.

In summary, various techniques for utilizing a plurality of device reboots are disclosed while utilizing OEM controlled processes for programming version OTPs. After a first reboot (e.g., cold reset 912), the updated OTA image is received and may be integrity checked and/or authenticated by trusted PBL/SBL as a trial image and executed. The processing device (and, in turn, OEMs) may monitor and collect needed device execution information and then cause the device to reboot after changing the type of the updated OTA image to current, while invalidating the previous current image. After a second reboot, the updated OTA image may be integrity checked and/or authenticated by a trusted PBL/SBL as a current image based on the updated anti-rollback OTPs and new version number in the image certificate, Under the present disclosure, status information (e.g., transition from trial to current in a rank file) may effectively be reused in the FWD stored in the off-chip NVM device as a flag controllable by OEM code, while at the same time maintaining anti-rollback OTP programming and lock at PBL/SBL stage.

In some illustrative examples, during a first reboot after receiving the OTA updated image, the PBL/SBL may only authenticate the OTA image and then execute the new image which is still marked as trial image, Only after the trial image is set to be current, followed by a subsequent second reboot, will the PBL/SBL update the version OTPs followed by inserting a one-time writable register as an OTP “Wr Permission Disable” to protect further malicious modification to the anti-rollback OTPs. In some illustrative examples, the PBL/SBL will only update the version OTPs if the image is “current” (i.e., not trial or default/golden). In this way the OEM may choose when to update FWD and whether the subsequent second reboot may be triggered immediately or at a later time when enough confidence about the fully functional OTA image is obtained (e.g., via 832-836). The one-time writable register may be configured to clear only after a cold reset and should be inserted by the PBL/SBL to prevent DoS attacks on the version OTPs.

### Exemplary Device and Method for Anti-Rollback Over-the-Air Updates

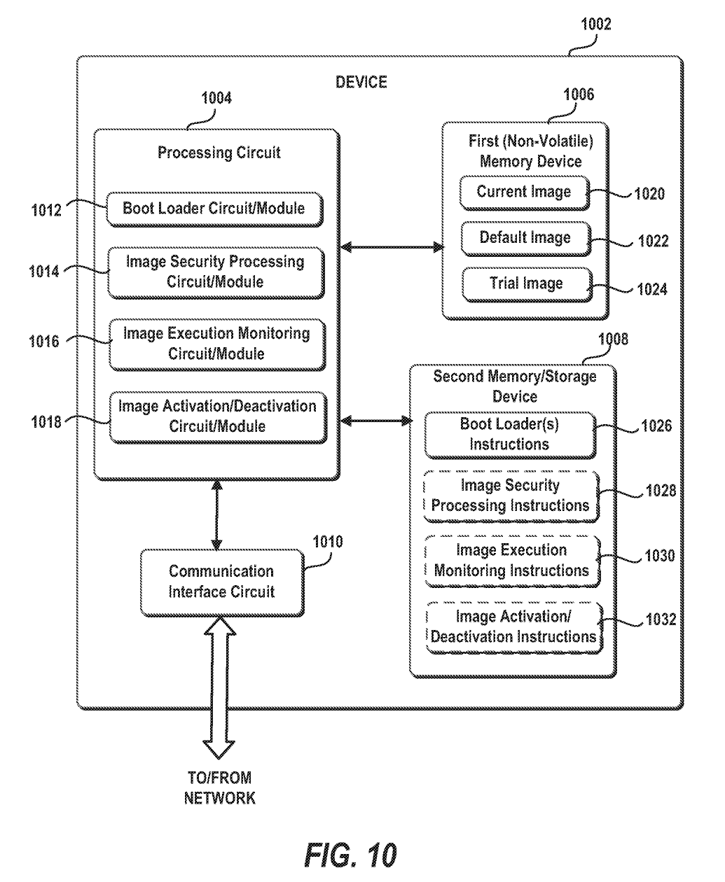

FIG. 10 illustrates an exemplary block diagram of a device configured to perform over-the-air updates with anti-rollback security. The device 1002 may include a processing circuit 1004, a first (non-volatile) memory device 1006, a second memory storage device 1008, and/or a communication interface circuit 1010.

The processing circuit 1004 may include a boot loader circuit/module 1012 configured to execute boot loader instructions (e.g., load an operating system, load firmware to operate the device, etc.). An image security processing circuit/module 1014 may serve to verify the security and/or authenticate device images that are loaded and/or executed. An image execution monitoring circuit/module 1016 may serve to monitor the execution of a device image and detect operating parameters (e.g., driver errors, execution errors, etc.). An image activation/deactivation circuit module 1018 may serve to activate and/or deactivate a device image.

The first (non-volatile) memory device 1006 may serve to store a current device image 1020, a default (golden) device image 1022, and/or a trial device image 1024.

The second memory/storage device 1008 may include boot loader instructions 1026 which may include image security processing instructions 1028, image execution monitoring instructions 1030, and/or image activation/deactivation instructions 1032.

The communication interface circuit 1010 may serve to couple the device 1002 to other devices over a wireless communication network. In one example, the communication interface circuit 1010 may serve to request, obtain, and/or receive a trial device image.

In one example, the processing circuit 1004 may be configured to: (a) initiate a first boot for the device, (b) instruct the at least one boot loader to perform security processing on the second device image and set and execute the second device image as a trial image after security processing on the second device image is successful, (c) monitor the executed second device image to determine if predetermined operational parameters in the device are met, and/or (d) set the second device image as a current image and deactivate the first device image if the predetermined operational parameters in the device are met. The at least one boot loader may be configured to activate a second boot for the device after setting the second device image as a current image. Additionally, the at least one boot loader may also be configured to modify a one-time programmable memory to indicate the setting of the second device image as the current image after setting the second device image as the current image. The one-time programmable memory may include a one-time programmable fuse.

In yet another example, the at least one boot loader may be configured to perform security processing via at least one of integrity check and/or authentication for the second device image. Additionally, the at least one boot loader is configured to deactivate the second device image and boot the device to load the first device image if the monitored executed second device image is determined to not meet the predetermined operational parameters.

In one example, receiving the second device image may include an over-the-air (OTA) transmitted second device image.

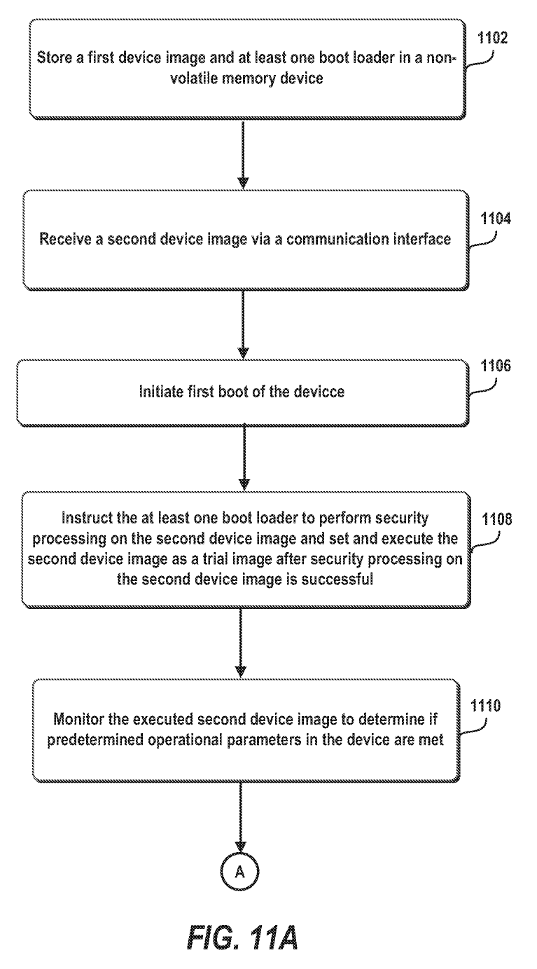

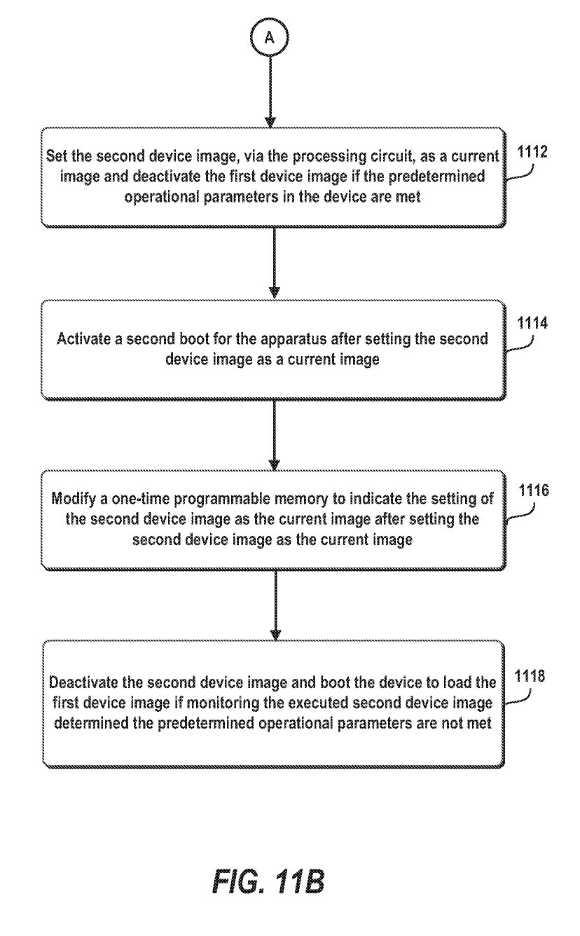

FIG. 11 (comprising FIGS. 11A and 11B) illustrates a method for updating a device image (e.g., programming and/or software) with anti-rollback capabilities. The device stores a first device image and at least one boot loader in a non-volatile memory device 1102. The first device image may be a default (golden) image (e.g., if the device is new and is using factory settings) or another image that was installed on the device. The device receives a second device image via a communication interface 1104 and initiates a first boot of the device 1106. In certain illustrative embodiments, the second device image may be an updated image for the device (e.g., OTA image). The at least one boot loader is instructed to perform security processing (e.g., integrity check, authentication) on the second device image and set and execute the second device image as a trial image after security processing on the second device image is successful 1108. The device monitors the executed second device image to determine if predetermined operational parameters in the device are met 1110.

The device sets the second device image, via the processing circuit, as a current image and deactivate the first device image if the predetermined operational parameters in the device are met 1112. A second boot may be activated for the device after setting the second device image as a current image. In order to implement anti-rollback protection, a one-time programmable memory may be modified 1116 to indicate the setting of the second device image as the current image after setting the second device image as the current image. This may include techniques, such as blowing a one-time programmable fuse. The second device image may be deactivated and the device may be booted to load the first device image, if monitoring the executed second device image determined the predetermined operational parameters are not met 1118.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other.

The various features of the disclosure described herein can be implemented in different systems without departing from the disclosure. It should be noted that the foregoing aspects of the disclosure are merely examples and are not to be construed as limiting the disclosure. The description of the aspects of the present disclosure is intended to be illustrative, and not to limit the scope of the claims. As such, the present teachings can be readily applied to other types of apparatuses and many alternatives, modifications, and variations will be apparent to those skilled in the art.

What is claimed is:

1. A device comprising:
a first memory for storing a first device image;
a second memory for storing at least one boot loader;
a communication interface for receiving a second device image; and
a processing circuit coupled to the first memory, the second memory, and the communication interface, wherein the processing circuit is configured to
initiate a first boot for the device,
instruct the at least one hoot loader to perform security processing on the second device image and set and execute the second device image as a trial image after security processing on the second device image is successful,
monitor the executed second device image to determine if predetermined operational parameters in the device are met, and
set the second device image as a current image and deactivate the first device image if the predetermined operational parameters in the device are met.

2. The device of claim 1, wherein the at least one boot loader is configured to activate a second boot for the device after setting the second device image as a current image.

3. The device of claim 1, wherein the at least one hoot loader is configured to modify a one-time programmable memory to indicate the setting of the second device image as the current image after setting the second device image as the current image.

4. The device of claim 3, wherein the one-time programmable memory includes a one-time programmable fuse.

5. The device of claim 1, wherein the at least one boot loader is configured to perform security processing via at least one of integrity check and/or authentication for the second device image.

6. The device of claim 1, wherein the at least one hoot loader is configured to deactivate the second device image and boot the device to load the first device image if the monitored executed second device image is determined to not meet the predetermined operational parameters.

7. The device of claim 1, wherein receiving the second device image includes an over-the-air (OTA) second device image.

8. A method for updating a device, comprising:
storing a first device image and at least one boot loader in a first memory;
receiving a second device image via a communication interface;
initiating a first boot of the device;
instructing the at least one boot loader to perform security processing on the second device image and setting and executing the second device image as a trial image after security processing on the second device image is successful;
monitoring the executed second device image to determine if predetermined operational parameters in the device are met; and
setting the second device image as a current image and deactivate the first device image if the predetermined operational parameters in the device are met.

9. The method of claim 8, further comprising:
activating a second boot for the device after setting the second device image as a current image.

10. The method of claim 8, further comprising:
modifying a one-time programmable memory to indicate the setting of the second device image as the current image after setting the second device image as the current image.

11. The method of claim 10, wherein modifying the one-time programmable memory includes blowing a one-time programmable fuse.

12. The method of claim 8, wherein performing security processing includes performing at least one of integrity check and/or authentication for the second device image via at least one of a primary boot loader and/or a secondary boot loader.

13. The method of claim 8, further comprising:
deactivating the second device image and booting the device to load the first device image if monitoring the executed second device image determined the predetermined operational parameters are not met.

14. The method of claim 8, wherein receiving the second device image includes receiving an over-the-air (PTA) second device image.

15. A machine-readable storage medium having instructions stored thereon which when executed by a processing circuit causes the processing circuit to:
store a first device image in a first memory;
receive a second device image via a communication interface;
initiate a first boot of the processing circuit;
instruct at least one boot loader to perform security processing on the second device image and set and execute the second device image as a trial image after security processing on the second device image is successful;
monitor the executed second device image to determine if predetermined operational parameters in a device are met; and
set the second device image as a current image and deactivate the first device image if the predetermined operational parameters in the device are met.

16. The machine-readable storage medium of claim 15, further having instructions stored thereon which when executed by the processing circuit causes the processing circuit to:
activate a second boot for the device after setting the second device image as a current image.

17. The machine-readable storage medium of claim 15, further having instructions stored thereon which, when executed by the processing circuit, causes the processing circuit to:
modify a one-time programmable memory to indicate the setting of the second device image as the current image after setting the second device image as the current image.

18. The machine-readable storage medium of claim 17, wherein the instructions to modify the one-time programmable memory includes instructions to blow a one-time programmable fuse.

19. The machine-readable storage medium of claim 15, wherein the instructions to perform security processing includes instructions to perform at least one of integrity check and/or authentication for the second device image via at least one of a primary boot loader and/or a secondary boot loader.

20. The machine-readable storage medium of claim 15, further having instructions stored thereon which, when executed by the processing circuit, causes the processing circuit to:
deactivate the second device image and booting the processing circuit to load the first device image if monitoring the executed second device image determined the predetermined operational parameters are not met.
